(19) United States
(12) Patent Application Publication
(10) Pub. No.: US 2010/0161732 A1
(43) Pub. Date: Jun. 24, 2010

(54) Methods, Systems, And Computer Program Products For Maintaining Consistency Between Non-Geospatial And Geospatial Network Directory Systems

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/339,675

(22) Filed: Dec. 19, 2008

(51) Int. Cl. G06F 15/16

(52) U.S. Cl. 709/206

(57) ABSTRACT

Maintaining consistency between non-geospatial and geospatial directory systems is described. A directory service, representing a domain in a domain space, updates a record associating location information identifying a location with a network identifier of a node and sends a message to a second directory service representing a second domain identifying a region at least partially including the location, in a geospatial domain space, for updating a record identifying the node at the second directory service. In another aspect, a directory service, representing a geospatial domain identifying a region in a geospatial domain space, updates a record associating a geospatial identifier identifying a geospatial location at least partially included in the region with a network identifier of a node and sends a message to a second directory service representing a second domain in a second domain space for updating a record identifying the node at the second directory service.

### RELATED APPLICATIONS

This application is related to the following commonly owned U.S. Patent Applications, the entire disclosure of each being incorporated by reference herein:

application Ser. No. 11/962,285 (Attorney Docket No 1509/US) filed on Dec. 21, 2007, entitled “Methods And Systems For Sending Information To A Zone Included In An Internet Network”;

application Ser. No. 12/170,281 (Attorney Docket No 1522/US) filed on Jul. 10, 2008, entitled “Methods And Systems For Resolving A Geospatial Query Region To A Network Identifier”;

application Ser. No. 12/170,829 (Attorney Docket No 1523/US) filed on Jul. 10, 2008, entitled “Methods And Systems For Resolving Location Information To A Network Identifier”;

application Ser. No. 12/170,833 (Attorney Docket No 1524/US) filed on Jul. 10, 2008, entitled “Methods And Systems For Resolving A Query Region To A Network Identifier”;

application Ser. No. 12/328,036 (Attorney Docket No 1496/US) filed on Dec. 4, 2008, entitled “Methods, Systems, And Computer Program Products For Browsing Using A Geospatial Map Metaphor”;

application Ser. No. 12/328,038 (Attorney Docket No 1508/US) filed on Dec. 4, 2008, entitled “Methods, Systems, And Computer Program Products For Associating Resources Of A First Geospace With A Second Geospace”;

application Ser. No. 12/328,048 (Attorney Docket No 1515/US) filed on Dec. 4, 2008 entitled “Methods, Systems, And Computer Program Products For Harmonizing A Geospatial Domain Space With A Non-Geospatial Domain Space”;

application Ser. No. 12/328,055 (Attorney Docket No 1516/US) filed on Dec. 4, 2008, entitled “Methods, Systems, And Computer Program Products For Accessing A Resource Based On Metadata Associated With A Location On A Map”;

application Ser. No. 12/328,059 (Attorney Docket No 1527/US) filed on Dec. 4, 2008, entitled “Methods, Systems, And Computer Program Products For Determining A Network Identifier Of A Node Providing A Type Of Service For A Geospatial Region”;

application Ser. No. 12/328,063 (Attorney Docket No 1534/US) filed on Dec. 4, 2008, entitled “Methods, Systems, And Computer Program Products For Accessing A Resource Having A Network Address Associated With A Location On A Map”;

application Ser. No. ______ (Attorney Docket No 1529/US) filed on ______, entitled “Methods, Systems, And Computer Program Products For Synchronizing Second Level Resources with First Level Resources Of A Multi-level Navigation History”; and

application Ser. No. ______ (Attorney Docket No 1530/US) filed on ______, entitled “Methods, Systems, And Computer Program Products For Presenting A Map In Correspondence With A Presented Resource.”

### BACKGROUND

The domain name system (DNS) is a hierarchical naming system for computers, systems, or any resource participating in a domain such as the Internet. It associates various information with domain names assigned to such participants. The DNS is maintained by a distributed database system. The nodes of this database are network directory services referred to as domain name servers. Each domain or subdomain has at least one DNS server (i.e. one network directory service) that maintains information for that domain.

The DNS is a network directory system. A network directory system is configured to maintain associations between a network identifier, such as a node domain name or a network address, and location information. When a network directory service in a network directory system detects a change in data, one or more associations are updated by one or more network directory services in the network directory system.

U.S. application Ser. No. 12/328,059 describes a geospatial network directory system in which some embodiments maintain information that is common in the currently used DNS network directory system. When either system detects a change in data that is common to both systems, the systems that must be consistent are no longer consistent.

### SUMMARY

There exists a need for methods, systems, and computer program products for maintaining consistency between the information between a non-geospatial network directory system (e.g., the current DNS system) and a geospatial network directory system.

Methods and systems are described for maintaining consistency between non-geospatial and geospatial network directory systems. In one aspect, a network directory service representing a first domain in a first domain space updates a first record associating first location information and a first network identifier. The first location information identifies a geospatial location associated with a node identified by the network identifier. A message is generated including change information based on the updating that identifies a record identifying the node at a second network directory service representing a geospatial domain in a second domain space. The geospatial domain identifies a geospatial region at least partially including the geospatial location. The message is sent to the second network directory service for updating the second record.

In one aspect, a system for maintaining consistency between non-geospatial and geospatial network directory systems includes means for updating, by a first network directory service representing a first domain in a first domain space, a first record associating first location information and a first network identifier. The first location information identifies a geospatial location associated with a node identified by the first network identifier. The system also includes means for generating a message including change information based on the updating. The message identifies a second record identifying the node at a second network directory service representing a geospatial domain in a second domain space. The geospatial domain identifies a geospatial region at least partially including the geospatial location. The system also includes means for sending the generated message to the second network directory service for updating the second record.

In another aspect, a system for maintaining consistency between non-geospatial and geospatial network directory systems includes a domain manager component in a first network directory service representing a first domain in a first domain space. The domain manager component is configured to update a first record associating first location information and a first network identifier. The first location information identifies a geospatial location associated with a node identified by the first network identifier. The system also includes a change agent component configured to generate a message including change information based on the updating. The message identifies a second record identifying the node at a second network directory service representing a geospatial domain in a second domain space. The geospatial domain identifies a geospatial region at least partially including the geospatial location. The system also includes a domain space agent component configured to send the generated message to the second network directory service for updating the second record.

In another aspect, a computer readable medium embodying a computer program, executable by a machine, for maintaining consistency between non-geospatial and geospatial network directory systems is defined. The computer program includes executable instructions for updating, by a first network directory service representing a first domain in a first domain space, a first record associating first location information and a first network identifier. The first location information identifies a geospatial location associated with a node identified by the first network identifier. The computer program also includes executable instructions for generating a message including change information based on the updating. The message identifies a second record identifying the node at a second network directory service representing a geospatial domain in a second domain space. The geospatial domain identifies a geospatial region at least partially including the geospatial location. The computer program also includes executable instructions for sending the generated message to the second network directory service for updating the second record.

In a further aspect, a first network directory service representing a geospatial domain in a geospatial domain space updates a record associating a geospatial identifier and a first network identifier. The geospatial identifier identifies a geospatial location at least partially included in a geospatial region identified by the geospatial domain and associated with a node identified by the first network identifier. A message is generated including change information based on the updating that identifies a second record identifying the node at a second network directory service representing a second domain in a second domain space. The message is sent to the second network directory system for updating the second record.

In another aspect a system for maintaining consistency between non-geospatial and geospatial network directory systems includes means for updating, by a first network directory service representing a geospatial domain in a geospatial domain space, a record associating a geospatial identifier and a first network identifier. The geospatial identifier identifies a geospatial location at least partially included in a geospatial region identified by the geospatial domain and associated with a node identified by the first network identifier. The system also includes means for generating a message including change information based on the updating. The message identifies a second record identifying the node at a second network directory service representing a second domain in a second domain space. The system also includes means for sending the generated message to the second network directory service for updating the second record.

In another aspect, a system for maintaining consistency between non-geospatial and geospatial network directory systems includes a geospatial domain manager component in a first network directory service representing a geospatial domain in a geospatial domain space. The geospatial domain manager is configured to update a record associating a geospatial identifier and a first network identifier. The geospatial identifier identifies a geospatial location at least partially included in a geospatial region identified by the geospatial domain and associated with a node identified by the first network identifier. The system also includes a change agent component configured to generate a message including change information based on the updating. The message identifies a second record identifying the node at a second network directory service representing a second domain in a second domain space. The system also includes a domain space agent component configured to send the generated message to the second network directory service for updating the second record.

In another aspect, a computer readable medium embodying a computer program, executable by a machine, for maintaining consistency between non-geospatial and geospatial network directory systems is defined. The computer program includes executable instructions for updating, by a first network directory service representing a geospatial domain in a geospatial domain space, a record associating a geospatial identifier and a first network identifier. The geospatial identifier identifies a geospatial location at least partially included in a geospatial region identified by the geospatial domain and associated with a node identified by the first network identifier. The computer program also includes executable instructions for generating a message including change information based on the updating. The message identifies a second record identifying the node at a second network directory service representing a second domain in a second domain space. The computer program also includes executable instructions for sending the generated message to the second network directory service for updating the second record.

### BRIEF DESCRIPTION OF THE DRAWINGS

Advantages of the claimed invention will become apparent to those skilled in the art upon reading this description in conjunction with the accompanying drawings, in which like reference numerals have been used to designate like or analogous elements, and in which:

FIG. 1 is a flow diagram illustrating a method for maintaining consistency between non-geospatial and geospatial network directory systems according to an aspect of the subject matter described herein;

FIG. 2 is block a diagram illustrating an arrangement of components for maintaining consistency between non-geospatial and geospatial network directory systems according to another aspect of the subject matter described herein;

FIG. 3 is a block diagram illustrating an exemplary execution environment in which the components of FIG. 2 are operable;

FIG. 4 is a block diagram illustrating a network having a node hosting an execution environment corresponding to the environment of FIG. 3 or FIG. 7 for hosting the components of FIG. 2 communicating with a non-geospatial network directory system and a geospatial network directory system according to an aspect of the subject matter described herein;

FIG. 5 is a flow diagram illustrating a method for maintaining consistency between non-geospatial and geospatial network directory systems according to another aspect of the subject matter described herein;

FIG. 6 is a block diagram illustrating an arrangement of components for maintaining consistency between non-geospatial and geospatial network directory systems according to another aspect of the subject matter described herein; and

FIG. 7 is a block diagram illustrating an exemplary execution environment in which the components of FIG. 6 are operable.

### DETAILED DESCRIPTION

The subject matter described herein provides for maintaining consistency between non-geospatial and geospatial network directory systems. This enables a non-geospatial network name directory system and a geospatial network directory system to maintain consistency allowing network addresses to be determined using either network directory system.

A geospatial domain space can include one or more domains where each domain is associated with a geospatial region. The geospatial region is referred to herein as a domain region. A domain and its domain region are identified by a geospatial identifier from the geospatial domain space. A location or region of a geospatial domain space can be associated with region information that uniquely identifies the region in the context of the geospatial domain space. Region information can include a geospatial identifier. For example, the surface of the Earth, in whole and in part, has been and continues to be identified based on various types of 2-dimensional and 3-dimensional identifier spaces. Some domain spaces are associated with a grid system where each grid is identified by a tuple of coordinates, for example, a coordinate pair where one identifies a region in a horizontal orientation, and one identifies a region in a vertical orientation. The coordinate pair together identify a region defined by the intersection of the horizontal region and the vertical region. Several forms of GPS coordinate spaces are currently in use including a Degrees/Minutes/Seconds domain space, a Degree Decimal Minutes domain space, and a Universal Transverse Mercator (UTM) domain space. A geospatial identifier associated with a geospatial domain space does not have to be coordinate-based. Any geospatial identifier that can identify regions/locations in a domain space is within the scope of the subject matter. For example, USA, N.C., Cary, 111 Corning Rd, Suite 220 is a geospatial identifier identifying a business work site in the space that is occupied by the Earth for identifying a region on the surface of the Earth.

A geospatial identifier includes any identifier that includes a portion that is usable for identifying a region/location of a geospatial domain space. Examples include:

postal://usa.nc.cary.corning-road:111.suite:220.placid

postal://placid.suite:220.corning_road:111.cary.nc.usa

postal://placid.suite:220:corning_road:111.27518.

Each of the above examples is from a geospatial domain space based the US Post Office geospatial domain space that includes postal addresses.

The table below provides examples of three geospatial identifiers each from a different geospatial domain space specifying the same region, region A, on the Earth. The first geospatial identifier is from the World Geographic System (WGS) geospatial domain space. The second geospatial identifier is from the commonly known latitude/longitude geospatial domain space for addressing Earth regions. Each of the latitude and longitude coordinates can be expressed in degrees, minutes, and/or seconds. The third geospatial identifier is from the Global Positioning System (GPS) geospatial domain space.

| | WGS | | Deg/Min/Sec | | GPS | |
|---|---|---|---|---|---|---|
| Region | Latitude | Longitude | Latitude | Longitude | Latitude | Longitude |
| Region A | 30.29128 | −97.73858 | 30° 17′ 28″ | −97° 44′ 18″ | N30 17.477 | W97 44.315 |

Geospatial identifiers can be defined for specifying regions and locations having a variety of shapes such as a rectangle, circle, oval, or any shape including a closed region. A geospatial identifier can identify a region with disjoint sub-regions by including a geospatial attribute that identifies the sub-regions. For example, the identifier, “40+”, from an identifier domain space including average annual rainfall totals over a specified period identifies a geospatial region including all sub-regions that have an average annual rainfall over 40 inches.

A geospatial identifier can include any of the forms and formats described above. Further a received geospatial identifier can be a network identifier in the form of geospatial network address or in the form of a geospatial name corresponding to at least a portion of a network address. A network identifier is an identifier for a network interface of a node in a network. A node is device with a network interface such as an Ethernet network interface card (NIC) and/or a wireless adapter. An Internet Protocol (IP) address is a network identifier for communicating over an IP network such as the Internet. The domain name system (DNS) includes a set of names that include network identifiers. The DNS system is configured for mapping a DNS name to a network address. A network identifier can be at least one of a network address and a symbolic identifier of a network address, such as a DNS name.

Both non-geospatial and geospatial network directory systems can maintain associations between a network identifier (e.g. a domain name or a network address), and location information. When either system detects a change in data that is common to both systems, the systems are not consistent and must be consistent. Messages exchanged among such systems can be defined to identify changed common data and identifying a common node associated with the changed data.

The process of making network directory systems consistent can be described as a process for maintaining consistency between two network directory services in two network directory systems. The data maintained by the different network directory systems does not have to be the same in order to be consistent. That is, synchronization and/or replication of data is not sufficient for many of the separate network directory systems. For example, a location (LOC) record in a non-geospatial network directory system with location information that specifies a geospatial region that is included in a region specified by location information maintained by the geospatial system is consistent, but the information in the two systems might not specify the same region

For a network directory system that maintains a network address, a network name, and location information associated with a node, there are minimally six different associations (12 total if associations can be unidirectional instead of bidirectional) that can be maintained between an Internet Protocol (IP) network address, a network name, and location information. A network directory system typically includes anywhere from 1 to 6 associations (for bidirectional associations). Caching can increase this number. A change can occur to any one of the 3 variables in this situation. Location information can change, an IP network address can change, and/or a network name can change.

For example, when an IP network address changes in the DNS, a network name to IP network address association, an IP network address to network name association, and an IP network address to location association can all require updating. The information that can be sent to a second network directory system includes the variable that changed and one or more old and/or current variable values for identifying associations in the second network directory system to be changed. In a geospatial network directory system, a changed IP network address can be sent along with one of the other variables. An exemplary geospatial network directory system can maintain location information to IP network address and an IP network address to location association. A second network directory system can also keep a copy of an IP network address to network name association to correlate changes with the DNS.

When an IP network address change is detected at a domain service in the DNS, the new IP network address and either the location or network name can be sent to a second network directory service in the second network directory system. One or more records including the old IP network address to be updated can be located based on the network name or location by the second network directory service. Alternatively, the new IP network address can be sent by the first network directory service with the old IP network address allowing the one or more records to be updated to be located based on the old IP network address by the second network directory service. All three of the variables are associated, although not directly in all instances. However, updating any one of the one-to-one associations, in effect, updates associations of the changed variable with all of the other variables directly or indirectly.

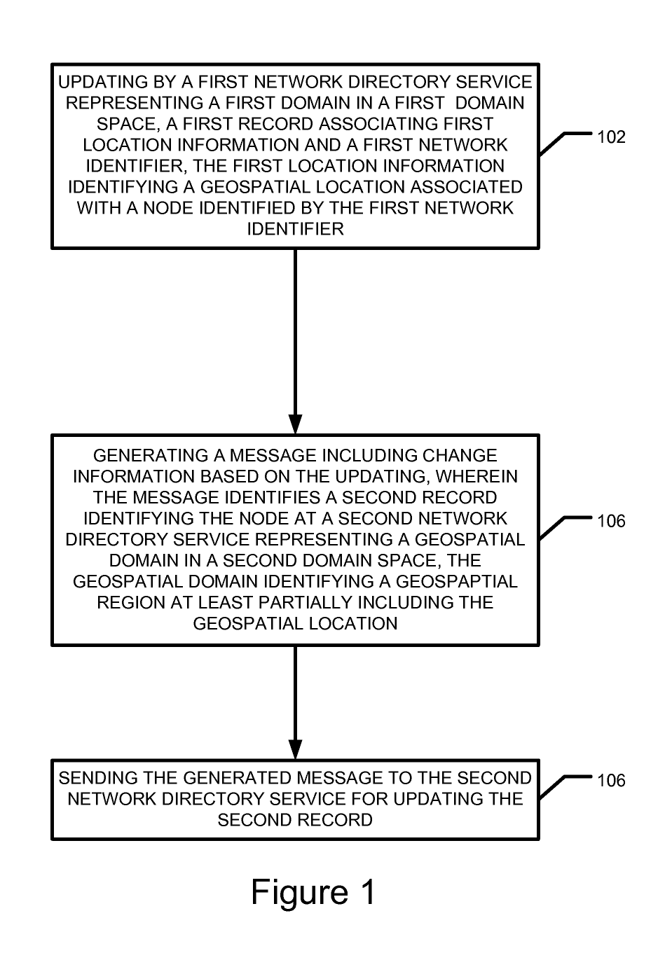

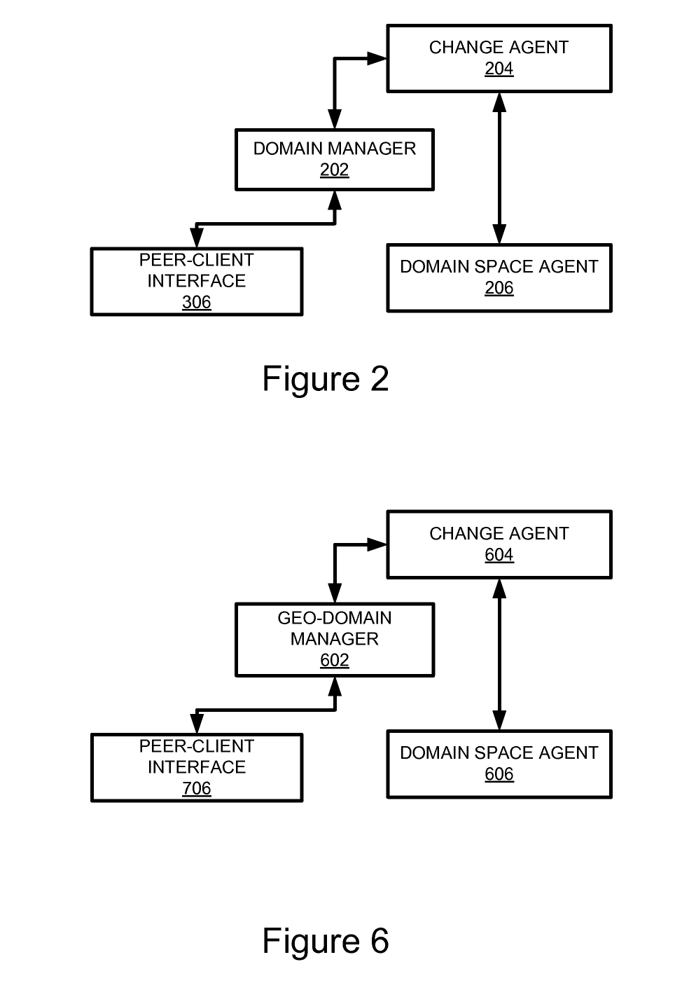

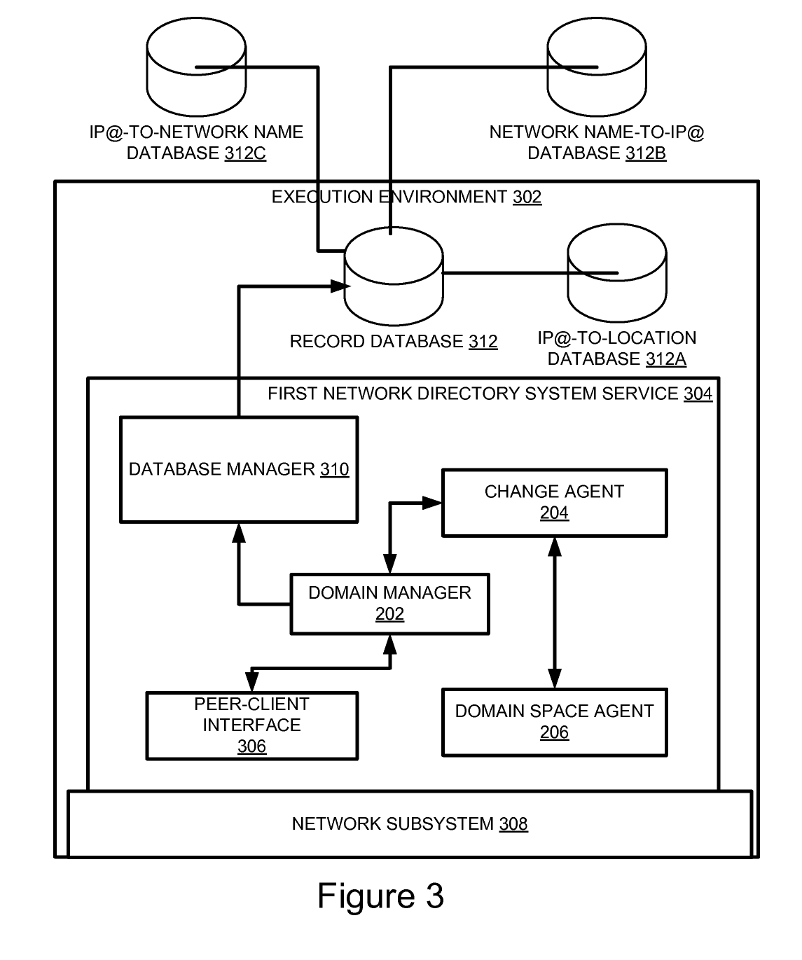

FIG. 1 is a flow diagram illustrating a method for maintaining consistency between non-geospatial and geospatial network directory systems according to an exemplary aspect of the subject matter described herein. FIG. 2 is a block diagram illustrating an arrangement of components for maintaining consistency between non-geospatial and geospatial network directory systems according to another exemplary aspect of the subject matter described herein. FIG. 3 is a block diagram illustrating an arrangement of components providing an execution environment 302 configured for hosting the arrangement of components of FIG. 2. The method illustrated in FIG. 1 can be carried out by, for example, some or all of the components illustrated in the exemplary arrangement of components illustrated in FIG. 2 operating in an a compatible execution environment, such as the execution environment 302 provided by some or all of the components illustrated in FIG. 3.

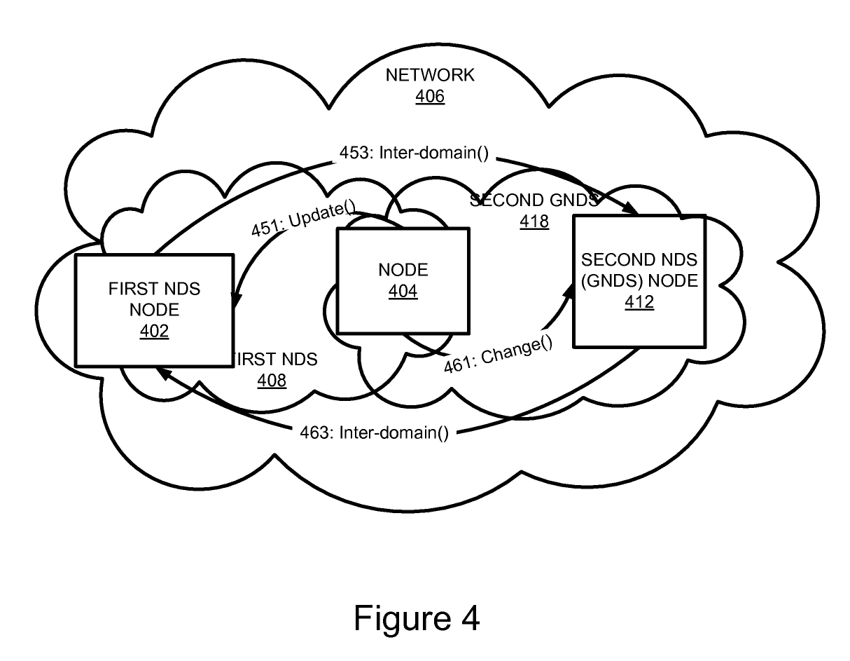

An execution environment can be hosted by a node and/or can be hosted by multiple nodes as in a distributed execution environment. FIG. 4 illustrates a plurality of nodes in a network. Each node can be configured to provide an execution environment. A first network directory system node 404 can provide the execution environment 302 adapted to support the operation of the components in FIG. 2. An exemplary execution environment includes a memory for storing components and an instruction processing component, such as processor and/or a digital signal processor (DSP), for processing instructions and any data associated with the operation of the components such as the components in FIG. 2. The components in FIG. 2 and functionally analogous arrangements of components each can require additional hardware and/or software subsystems according to their particular operational requirements. For example, a network subsystem can be included in the execution environment 302 for communicating with a component in a remote device, such as a node 402 over a network 406 as will be described. An operating system, persistent data storage subsystem, memory management subsystem, and/or a process scheduler are other examples of components that can be required for various adaptations of the components in FIG. 2 and its functional analogs for performing the method in FIG. 1.

In the description that follows, the current DNS is described as an example network directory system. Those skilled in the art will recognize that the description herein applies to any network directory system for resolving network identifiers of nodes in a network.

With reference to FIG. 1, in block 102 a first network directory service representing a first domain in a first domain space updates a first record associating first location information and a first network identifier, the first location information identifying a geospatial location associated with a node identified by the first network identifier. Accordingly, a system for maintaining consistency between non-geospatial and geospatial network directory systems includes means for updating by a first network directory service representing a first domain in a first domain space, a first record associating first location information and a first network identifier, the first location information identifying a geospatial location associated with a node identified by the first network identifier. For example, as illustrated in FIG. 2, a domain manager component 202 of a first network directory service representing a first domain in a first domain space is configured to update a first record associating first location information and a first network identifier, the first location information identifying a geospatial location associated with a node identified by the first network identifier.

Turning now to FIGS. 2, 3, and 4, FIG. 2 includes a domain manager component 202 configured to update a record based on update information received by the domain manager component 202. The domain manager component 202 can be included in a first network directory system service 304 operating in an execution environment 302 provided by the first network directory system node 402. The first network directory system service 304 can maintain records for nodes, such as the node 404 in a first domain in a first domain space represented by a first network directory system 408.

FIG. 4 illustrates nodes in the first network directory system 408 included in the network 406. The network 406 provides communication between at least some of the nodes in the first network directory system 408 and at least some nodes included in a second network directory system 418 representing a second domain space.

The domain manager component 202 operating in the execution environment 302 provided by the first network directory system node 402 can receive update information from the node 404 or on behalf of the node 404 in a update message 451 for updating a first record including a network identifier of the node 404 and/or first location information identifying a geospatial location of the node 404. Updating can include creating, deleting, and/or modifying a record. The first network identifier of the node 404 can be a network address from a network address domain space or a symbolic identifier such as a network name from a name domain space such as the current domain name system (DNS). Alternatively, the domain manager component 202 can receive update information from another network directory system node in the first network directory system 408. The other network directory system service operating in the other network directory system node, for example, can be: an authoritative network directory system service for the first domain represented by the first network directory system service 304; a peer, parent, or child network directory system service; or a relay in the first network directory system 408 for relaying an update message 451 including update information from the first network directory system 408. Updates from nodes within the first network directory system 408 can be received via a peer-client interface component 306 via a network subsystem 308 as illustrated in FIG. 3. The network subsystem 308 can be operatively coupled to the network 406 for receiving update messages including update information.

Alternatively or additionally, update information can be received by the domain manager component 202 via user input from a local or remote interface in communication with the first network directory system service 304. Further, update information can be loaded from a persistent data store either local to the first network directory system node 402 or hosted by a remote node (not shown). Update information can be received through any input interface supported by the execution environment 302 and the first network directory system service 304 in any format for which the first network directory system service 304 is configured.

The node 404 is identified by a first network identifier and has a geospatial location identified by first location information. The first network identifier is associated with the first location information by one or more records maintained by a database manager component 310 configured to store the one or more records in a record database component 312. The association can be direct where a record includes the first network identifier and the first location information. For example, the current DNS supports a LOC record that associates an Internet Protocol (IP) network address with location information. For example, a record including a network address and a location can be stored in an IP@-to-location database 312A portion of the record database component 312.

Note that the association can be an indirect association. For example, the current DNS system supports an A record for IPv4 and an AAAA record for IPv6 that is provided to associate a network identifier from the DNS name space to an IP network address. Records for network name-to-network address associations can be stored in a network name-to-IP@ database 312B portion of the record database component 312. The network name is thus associated with the first location of the node 404 via the IP network address based on an A or AAAA record and a LOC record.

The records in the DNS are unidirectional allowing one-way lookups. A record allows a network name to be mapped to a network address. A LOC record allows an IP network address to be mapped to location information. Those familiar with the DNS will know that the current DNS supports a PTR record for associating an IP network address with a network name. PTR records can be stored in an IP@-to-network name database 312C portion of the record database component 312.

Those skilled in the art will understand, given the description herein, that network name-to-location records, location-to-network name, and location-to-network address records can be supported as an alternative or in addition to the current records supported by the current DNS and/or other network directory system illustrated in the Figures. An alternative network directory system, for example, can be configured to support records for bidirectional lookup and resolution.

Update information can also be received by the domain manager component 202 in an inter-domain change message (not shown) that includes update information from another network directory system, such as a node in the second network directory system 418 or a network directory system not depicted in FIG. 4.

When update information is received, for example via the peer-client interface 306, by the domain manager component 202, the domain manager component 202 can determine whether a record managed by the first network directory system service 304 requires updating based on the update information. In FIG. 3, the determination is performed by the domain manager component 202 interoperating with the database manager component 310 to identify an existing or a needed record identified based on a network identifier, and/or location information included in the update information. A needed record is a record for a node with a network identifier according to the update information that is in the domain represented by the network directory system service 304. If no existing record is located and no new record is needed, the domain manager component 202 and the peer-client interface component 306 interoperate to relay the message 451 to another network directory system node representing a domain, indicated by the update information, in the first network directory system 408 via the network subsystem 308 and the network 406. If such a record exists or should be created, the domain manager component 202 can interoperate with the database manager component 310 to update the first record including creating the first record when necessary, for example, associating the first network identifier of the node 404 with the first location information of the node 404 in the record database component 312. In some cases, multiple records can be updated based on the update information and the database structure of a particular configuration of a network directory system service.

Note for purposes of the description herein, the first network identifier can be included in the update information and in a record such as the first record after the update has been performed or the first network identifier can be a value replaced in a record, such as the first record, as a result of the update operation. Similarly, the first location information can be included in the update information and in a record such as the first record after the update has been performed or the first network identifier can be a value replaced in a record, such as the first record, as a result of the update operation.

Other network directory systems can be linked to the first network directory system 408 by linking a network identifier and/or location identifier maintained by the first network directory system 408 with a network identifier and/or location identifier maintained by the second network directory system, such as the second geospatial network directory system 418. For example each of the first network directory system 408 and the second network directory system 418 can maintain an association between a network name in a domain in the first network directory system 408 and a network name in a domain in the second network directory system 418. Analogously, any network identifier to network identifier association, location information to location information association, and/or network identifier to location information association can link a node in the first network directory system 408 to the same node and/or common location information associated with the second network directory system 418.

Returning to FIG. 1, in block 104 a message is generated including change information based on the updating. The message identifies a second record identifying the node at a second network directory service representing a geospatial domain in a second domain space. The geospatial domain identifies a geospatial region at least partially including the geospatial location. Accordingly, a system for maintaining consistency between non-geospatial and geospatial network directory systems includes means for generating a message including change information based on the updating, wherein the message identifies a second record identifying the node at a second network directory service representing a geospatial domain in a second domain space, the geospatial domain identifying a geospatial region at least partially including the geospatial location. For example, as illustrated in FIG. 2, a change agent component 204 is configured to generate a message including change information based on the updating (e.g., based on the update information and/or updated first record), wherein the message identifies a second record identifying the node at a second network directory service representing a geospatial domain in a second domain space, the geospatial domain identifying a geospatial region at least partially including the geospatial location.

The change agent component 204 can be invoked by the domain manager component 202 as illustrated in FIG. 2 and in FIG. 3. The domain manager component 202 can provide access to the update information and/or the updated record or records. The change agent component 204 can be configured to generate an inter-domain message 453 that includes change information based on the update processing for updating the first record and optionally related records. Additionally, the inter-domain message 453 can identify at least one of a network identifier and a location shared by the first network directory system node 402 in the first network directory system 408 and a second network directory system node 412 in the second network directory system 418. The network identifier may be a network address and/or at least a portion of a host identifier. The shared network identifier and/or the location information identify a second record associated with the node 404 in a geospatial domain in the second network directory system 418. The second network directory system 418 represents a second domain space including the geospatial domain. A domain space including geospatial domains is referred to as a geospatial domain space. The geospatial domain identifies a geospatial region that at least partially includes the location of the node 404 maintained by the first network directory system 408.

Returning to FIG. 1, in block 106 the generated message is sent to the second network directory service for updating the second record. Accordingly, a system for maintaining consistency between non-geospatial and geospatial network directory systems includes means for sending the generated message to the second network directory service for updating the second record. For example, as illustrated in FIG. 2, a domain space agent component 206 is configured to send the generated message to the second network directory service for updating the second record. The generated message can be sent using an asynchronous protocol.

FIG. 2 and FIG. 3 illustrate the domain space agent component 206 is configured to interoperate with the change agent component 204 to send the inter-domain message 453 to the second network directory system 418 via the network subsystem 308 and the network 406. The change information in the inter-domain message 453 is for updating the second record maintained by the second network directory system node 412 representing the geospatial domain identifying the geospatial region at least partially including the first geospatial location.

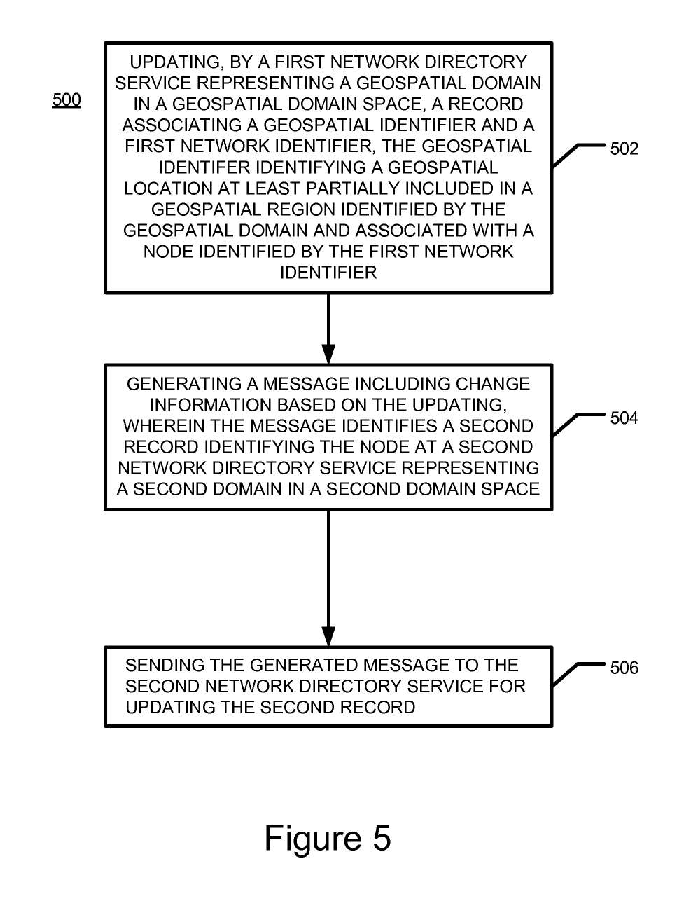

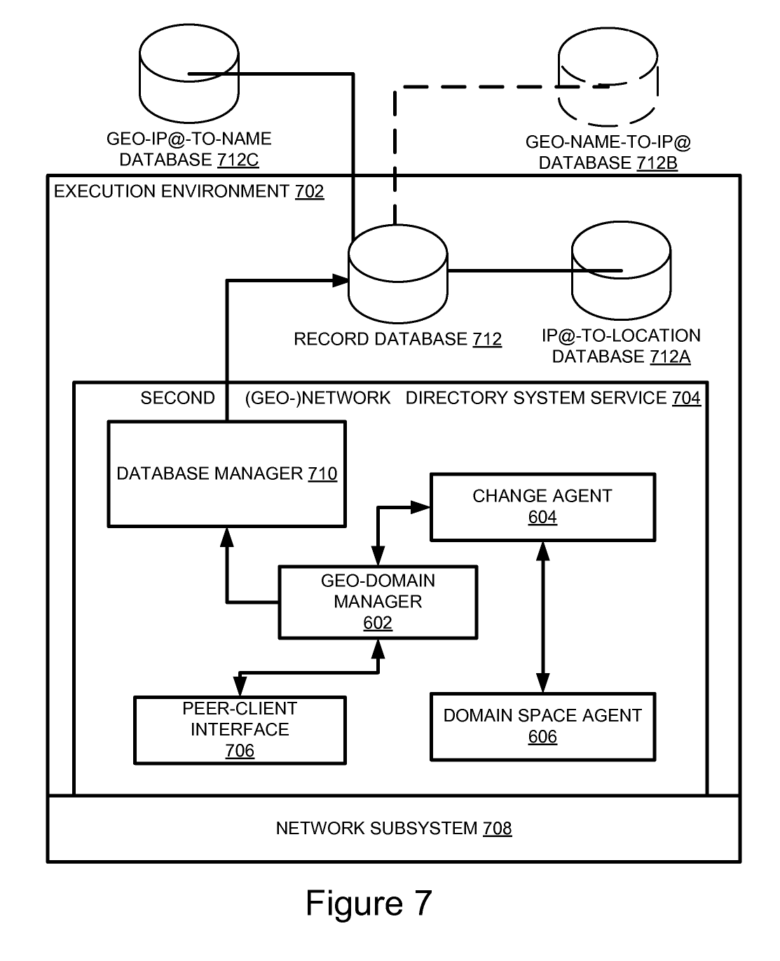

FIG. 5 is a flow diagram illustrating a method for maintaining consistency between non-geospatial and geospatial network directory systems according to an exemplary aspect of the subject matter described herein. FIG. 6 is a block diagram illustrating an arrangement of components for maintaining consistency between non-geospatial and geospatial network directory systems according to another exemplary aspect of the subject matter described herein. FIG. 7 is a block diagram illustrating an arrangement of components providing an execution environment 702 configured for hosting the arrangement of components of FIG. 6. The method illustrated in FIG. 5 can be carried out by, for example, some or all of the components illustrated in FIG. 2 or their analogs operating in an a compatible execution environment, such as the execution environment 702 illustrated in FIG. 7.

With reference to FIG. 5, in block 502 a first network directory service representing a geospatial domain in a geospatial domain space updates a record associating a geospatial identifier and a first network identifier. The geospatial identifier identifies a geospatial location at least partially included in the geospatial region and associated with a node identified by the first network identifier. Accordingly, a system for maintaining consistency between non-geospatial and geospatial network directory systems includes means for updating, by a first network directory service representing a geospatial domain in a geospatial domain space, a record associating a geospatial identifier and a first network identifier, the geospatial identifier identifying a geospatial location at least partially included in the geospatial region and associated with a node identified by the first network identifier. For example, as illustrated in FIG. 6, a geospatial domain manager component 602 is configured to update a record associating a geospatial identifier and a first network identifier, the geospatial identifier identifying a geospatial location at least partially included in the geospatial region and associated with a node identified by the first network identifier.

FIG. 6 includes a geospatial domain manager component 602 configured to update a record based on update information received by the geospatial domain manager component 602. FIG. 7 illustrates a geospatial domain manager component 602 adapted to operate in a second network directory system service 704 operating in an execution environment 702 provided by the second network directory system node 412. The second network directory system service 704 can maintain records for nodes, such as the node 404 in the second domain in the second network directory system 418. The second network directory system 418 represents a geospatial domain space where the second domain is a geospatial domain that identifies a geospatial region.

The nodes in the second network directory system 418 are included in the network 406 which provides communication between at least some of the nodes in the second network directory system 418 and at least some nodes included in the first network directory system 408 as described above. The node 404 that is included in the second domain is associated with a geospatial location that is at least partially included in the geospatial region of the second domain. The geospatial location of the node 404 is identified by a geospatial identifier. The geospatial domain manager component 704 can be configured to maintain one or more records associating the geospatial identifier with a second network identifier identifying the node 404. The second network identifier can be included in an identifier space associated with the second domain in the second network directory system 418. The second network identifier can be a geospatial identifier or a non-geospatial identifier. The second network identifier can be a network address, such as a geospatial network address, or a symbolic network identifier, such as a geospatial name from a geospatial name space.

The geospatial domain manager component 602 operating in the execution environment 702 provided by the second network directory system node 412 can receive update information from the node 404 or on behalf of the node 404 in a change message 461 illustrated in FIG. 4 for updating a second record including a network identifier of the node 404 and/or the geospatial identifier of the location of the node 404. Updating can include creating, deleting, and/or modifying a record. The second network identifier of the node 404 can be a network address from a network address space, such as a geospatial network address space, or a symbolic identifier such as a name from a geospatial name space. Alternatively, the geospatial domain manager component 602 can receive update information from another network directory system node in the second network directory system 418. The other network directory system node, for example, can be: an authoritative network directory system node for the second domain of the second network directory system service 704; a peer, parent, or child network directory system service; or a relay in the second network directory system 418 for relaying the change message 461 including update information from the other network directory system node or from a node in the second network directory system 418. Updates from network directory system nodes within the second network directory system 418 can be received via a peer-client interface 706 via a network subsystem 708. The network subsystem 708 can be operatively coupled to the network 406 for receiving update messages including update information.

Alternatively or additionally update information can be received by the domain manager component 602 via user input from a local or remote interface in communication with the second network directory system service 704. Further, update information can be loaded by the geospatial domain manager component 602 from a persistent data store either local to the second network directory system node 412 or hosted by a remote node (not shown). Update information can be received through any input interface supported by the execution environment 702 and the second network directory system service 704 in any format for which the second network directory system service 704 is configured.

The node 404 is identified by the second network identifier and has a geospatial location identified by the geospatial identifier. The second network identifier is associated with the geospatial identifier by one or more records managed by a database manager component 710 and stored in a record database component 712. Alternatively the geospatial identifier can be included in or otherwise based on the second network identifier. The association can be direct where a record includes the second network identifier and the geospatial identifier as described above with respect to the first network directory system 408. As with the record database component 312, the record database component 712 can support a record that associates a network address with a geospatial identifier. As indicated, such a record can be unnecessary when the network identifier is a geospatial network identifier from which the geospatial identifier of the location is determined. The association can be direct or indirect as described above with respect to the first network directory system 408.

FIG. 7 illustrates a geospatial network directory system service 704 that can include or otherwise be operatively coupled to a geo-ip@-to-name database 712C portion of the record database component 712 providing storage for records mapping a geospatial network address to a symbolic name such as a DNS name. In a second network domain system 418 that supports only a network address identifier space, these records are sufficient for the system and method described in this document. Alternatively or additionally, a geo-name-to-IP@ database 712B portion of the record database component 712 can be maintained for resolving geospatial names from a name space of the second network domain space to an IP network address shared with the first network directory system 408. That is the node 404, can have a single IP network address and a name from a name space of the first network directory system 408 and a geospatial name from a geospatial name space of the second network directory system 418. Alternatively or additionally, a network address-to-location database, illustrated as an IP@-to-location database 712A, portion can be maintained. The location information maintained by the first network directory system service 304 for the node 404 can at least partially include the geospatial location maintained by the second network directory system service 704. Alternatively or additionally, a network name-to-location database (not shown) portion of the record database component 712 can be maintained. The first location information maintained by the first network directory system service 304 for the node 404 can at least partially include the geospatial location maintained by the second network directory system service 704. When a network identifier maintained by the second network directory system service 704 is in a geospatial identifier space of the second network domain space, the geospatial identifier can itself associate the network address with the geospatial identifier of the location when the geospatial identifier of the location is or is otherwise based on the geospatial network identifier.

The node 404 can be present in one location and be associated with an owner based in another location. If the node 404 is associated with more than one geospatial location, a geospatial network identifier-to-geospatial identifier database can be provided. One example of a geospatial network identifier-to-geospatial network identifier database is a geospatial network address-to-geospatial network-name database. At least one of the identified geospatial locations is at least partially included in the region identified by the second domain. The other geospatial location can be at least partially included in regions of other domains of the second network directory system 418 or can be associated with other network domain spaces. For example, the first network directory system 408 can be a geospatial domain space. The first network domain space, for example, can associate nodes with names from a name space based on US Postal System street addresses and the second network directory system 418 can associate a network address from a geospatial network address space based on a GPS coordinate space.

In an alternative, an IP@-to-name database portion of a record database can be provided allowing indirect associations between an IP network address associated with a node by the first network directory system 408 to be linked to a geo-IP network address associated with the node by the second network directory system 418 via, for example, a name shared by both the first network directory system 408 and the second network directory system 418. The name field in the records in the geo-ip@-to-name database 712C portion and the geo-name-to-ip@ database 712B portion associate an IP network address with a geo-IP network address both of which can identify a node such as node 404.

Records supported by the second network directory system service 704 in the record database component 712 can support unidirectional and/or bidirectional associations as described above with respect to the first network directory system service 304. As with the first network directory system service 304, those skilled in the art will understand given the description herein that the records in the depicted database component 712 and the associations supported are exemplary and not meant to be exhaustive.

As described with respect to the first network directory system service 304, update information can also be received by the geospatial domain manager component 602 in an inter-domain change message that includes update information from another network domain space, such as a node in the first network directory system 408 or a network domain space not depicted in FIG. 4.

When update information is received, for example via the peer-client interface component 706, by the geospatial domain manager component 602, the geospatial domain manager component 602 can determine whether a record managed by the second network directory system service 704 requires updating based on the update information. The determination can be performed by the geospatial domain manager component 602 interoperating with the database manager component 710 to identify an existing or a needed record (a record belonging in the domain represented) identified based on a network identifier and/or location information, such as a geospatial identifier, included in the update information. If no such record is located and no new record is needed, the geospatial domain manager component 602 can copy or otherwise relay the message 461 via the peer-client interface 706 and network subsystem 708 over the network 406 to another network domain space node in the second network directory system 418. If such a record exists, the geospatial domain manager component 602 interoperates with the database manager component 710 to update the second record associating the second network identifier of the node 404 with the geospatial identifier the node 404 in the record database component 712. In some cases, multiple records can be updated based on the update information and the database structure.

Note for purposes of the description herein, the second network identifier can be included in the update information and in a record such as the second record after the update has been performed or the second network identifier can be a value replaced in a record, such as the second record, as a result of the update operation. Similarly, the geospatial identifier can be included in the update information and in a record such as the second record after the update has been performed or the geospatial identifier can be a value replaced in a record, such as the second record, as a result of the update operation.

Other network directory systems can be linked to the second network directory system 418 by linking a network identifier and/or location identifier maintained by the second network directory system 418 with a network identifier and/or location identifier maintained by the other network directory system, such as the first network directory system 408. As with the first network directory system 408, any network identifier to network identifier association, location information to location information association, and/or network identifier to location information association can link the node 404 in the second network directory system 418 to the same node 404. Likewise a shared location can also be used to maintain the link.

Returning to FIG. 5, in block 504 a message is generated including change information based on the updating, wherein the message identifies a second record identifying the node at a second network directory service representing a second domain in a second domain space. Accordingly, a system for maintaining consistency between non-geospatial and geospatial network directory systems includes means for generating a message including change information based on the updating, wherein the message identifies a second record identifying the node at a second network directory service representing a second domain in a second domain space. For example, as illustrated in FIG. 6, a change agent component 604 is configured to generate a message including change information based on the updating, wherein the message identifies a second record identifying the node at a second network directory system representing a second network domain space. In one aspect, the change agent component 604 generates the message when a determination is made that updating the first record requires the second record to be updated. In another aspect, the change information is based upon the update information and/or the updated first record.

FIG. 6 includes a change agent component 604 that can be invoked by the geospatial domain manager component 602. The geospatial domain manager component 602 can provide access to the update information and/or the updated record or records. The change agent component 604 can be configured to generate an inter-domain message 463 that includes change information based on the update processing for updating the second record and optionally related records. Additionally the inter-domain message 463 can identify at least one of a network identifier and a location shared by the second network directory system service 704 and the first network directory system service 304 hosted by the nodes 412 and 402 respectively. The shared network identifier and/or the shared location identify the second record associated with the node 404 in the second domain in the second domain space represented by the second network directory system 418. The second domain space represented by the second network directory system 418 includes the second domain that is a geospatial domain. The geospatial domain identifies a geospatial region that at least partially includes the first geospatial location of the node 404 maintained by the second network directory system 418.

Returning to FIG. 5, in block 506 the generated message is sent to the second network directory service for updating the second record. Accordingly, a system for maintaining consistency between non-geospatial and geospatial network directory systems includes means for sending the generated message to the second network directory service for updating the second record. For example, as illustrated in FIG. 6, a domain space agent component 606 is configured to send the generated message to the second network directory service for updating the second record. The generated message can be sent using an asynchronous protocol

FIG. 6 includes a domain space agent component 606 configured to interoperate with the change agent component 604 for sending the inter-domain message 463 to the first network directory system 408 via the network subsystem 708 and the network 406. The change information in the inter-domain message 463 is for updating the record maintained by the first network directory system node 402 representing the first domain.

It should be understood that the various system components (and means) defined by the claims and illustrated in the various block diagrams represent logical components that are configured to perform the functionality described herein. While at least one of these components are implemented at least partially as an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Moreover, the methods described herein can be embodied in executable instructions stored in a computer readable medium for use by or in connection with an instruction execution machine, apparatus, or device, such as a computer-based or processor-containing machine, apparatus, or device. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for maintaining consistency between non-geospatial and geospatial network directory systems, the method comprising:
updating, by a first network directory service representing a first domain in a first domain space, a first record associating first location information and a first network identifier, the first location information identifying a geospatial location associated with a node identified by the first network identifier;
generating a message including change information based on the updating, wherein the message identifies a second record identifying the node at a second network directory service representing a geospatial domain in a second domain space, the geospatial domain identifying a geospatial region at least partially including the geospatial location; and
sending the generated message to the second network directory service for updating the second record,
wherein at least one of the preceding actions is performed on at least one electronic hardware component.

2. The method of claim 1 wherein the message includes geospatial information and an associated network identifier.

3. The method of claim 3 wherein the associated network identifier comprises at least one of a network address and at least a portion of a host identifier.

4. The method of claim 1 wherein sending the generated message comprises sending the generated message using an asynchronous protocol.

5. The method of claim 1 wherein updating the first record includes one of creating, editing, and modifying a record.

6. The method of claim 1 wherein the first network identifier comprises at least one of a network address from a network address space and a symbolic identifier from a name space.

7. The method of claim 1 further comprising receiving update information for updating the first record.

8. The method of claim 7 wherein the change information is based upon the update information.

9. The method of claim 7 wherein receiving the update information comprises receiving the update information from at least one of another network directory service in the first network domain space, a persistent data store, and an inter-domain change message.

10. The method of claim 1 further comprising receiving update information for updating the first record from an other network directory service that has made a determination that the update information does not require a record managed by the other network directory service to be updated.

11. The method of claim 1 wherein generating the message includes identifying at least one of a network identifier and a location shared by a first network directory system including the first network directory system service and a second network directory system including the second network directory system service, the at least one of the network identifier and the location shared by the first network directory system and the second network directory system identifying the second record associated with the node at the second network directory service.

12. The method of claim 1 further comprising receiving update information for updating the first record via user input.

13. The method of claim 12 wherein receiving update information for updating the first record via user input comprises receiving update information for updating the first record via user input from at least one of a local interface and a remote interface in communication with the first network directory service.

14. A method for maintaining consistency between non-geospatial and geospatial network directory systems, the method comprising:
updating, by a first network directory service representing a geospatial domain in a geospatial domain space, a record associating a geospatial identifier and a first network identifier, the geospatial identifier identifying a geospatial location at least partially included in a geospatial region identified by the geospatial domain and associated with a node identified by the first network identifier;
generating a message including change information based on the updating, wherein the message identifies a second record identifying the node at a second network directory service representing a second domain in a second domain space; and
sending the generated message to the second network directory service for updating the second record,
wherein at least one of the preceding actions is performed on at least one electronic hardware component.

15. The method of claim 14 further comprising receiving update information for updating the first record.

16. The method of claim 15 wherein the change information is based upon the update information.

17. The method of claim 15 wherein receiving the update information comprises receiving the update information from at least one of another network directory service in a first network directory system representing the first domain space, a persistent data store, and an inter-domain change message.

18. The method of claim 14 further comprising receiving update information for updating the first record from an other network directory service that has made a determination that the update information does not require a record managed by the other network directory system to be updated.

19. The method of claim 14 further comprising receiving update information for updating the first record from an other network directory service that has updated a record in the other network directory service based on the update information.

20. The method of claim 14 wherein the first network identifier comprises one of a geospatial network address and a geospatial name from a geospatial name space.

21. The method of claim 14 further comprising receiving update information for updating the first record via user input.

22. The method of claim 22 wherein receiving update information for updating the first record via user input comprises receiving update information for updating the first record via user input from at least one of a local interface and a remote interface in communication with the first network directory service.

23. The method of claim 14 further comprising providing a geospatial network identifier to geospatial identifier database when the node identified by the first network identifier is associated with more than one geospatial location.

24. The method of claim 23 wherein at least one of the more than one geospatial location is associated with other network domain spaces.

25. A system for maintaining consistency between non-geospatial and geospatial network directory systems, the system comprising:
means for updating, by a first network directory service representing a first domain in a first domain space, a first record associating first location information and a first network identifier, the first location information identifying a geospatial location associated with a node identified by the first network identifier;
means for generating a message including change information based on the updating, wherein the message identifies a second record identifying the node;
at a second network directory service representing a second domain space, the geospatial domain identifying a geospatial region at least partially including the geospatial location; and
means for sending the generated message to the second network directory service for updating the second record,
wherein at least one of the means includes at least one electronic hardware component.

26. A system for maintaining consistency between non-geospatial and geospatial network directory systems, the system comprising system components including:
a domain manager component in a first network directory service representing a first domain in a first domain space, the domain manager component configured to update a first record associating first location information and a first network identifier, the first location information identifying a geospatial location associated with a node identified by the first network identifier;
a change agent component configured to generate a message including change information based on the updating, wherein the message identifies a second record identifying the node at a second network directory service representing a geospatial domain in a second domain space, the geospatial domain identifying a geospatial region at least partially including the geospatial location; and
a domain space agent component configured to send the generated message to the second network directory service for updating the second record,
wherein at least one of the system components includes at least one electronic hardware component.

27. The system of claim 26 wherein the message includes geospatial information and an associated network identifier.

28. The system of claim 27 wherein the associated network identifier comprises at least one of a network address and at least a portion of a host identifier.

29. The system of claim 26 wherein the domain manager component is configured to update the first record including one of creating, editing, and modifying a record.

30. The system of claim 26 wherein the domain manager component is further configured to receive update information for updating the first record.

31. The system of claim 30 wherein the domain manager component is configured to receive the update information from at least one of another network directory system in the first network domain space, a persistent data store, and an inter-domain change message.

32. The system of claim 26 wherein the domain manager component receives update information for updating the first record via user input.

33. The system of claim 32 wherein receiving update information for updating the first record via user input comprises receiving update information for updating the first record via user input from at least one of a local interface and a remote interface in communication with the first network directory system.

34. A system for maintaining consistency between non-geospatial and geospatial network directory systems, the system comprising:
means for updating, by a first network directory service representing a geospatial domain in a geospatial domain space, a record associating a geospatial identifier and a first network identifier, the geospatial identifier identifying a geospatial location at least partially included in the geospatial region identified by the geospatial domain and associated with a node identified by the first network identifier;
means for generating a message including change information based on the updating, wherein the message identifies a second record identifying the node at a second network directory service representing a second domain in a second domain space; and
means for sending the generated message to the second network directory service for updating the second record,
wherein at least one of the means includes at least one electronic hardware component.

35. A system for maintaining consistency between non-geospatial and geospatial network directory systems, the system comprising system components including:
a geospatial domain manager component in a first network directory service representing a geospatial domain in a geospatial domain space, the geospatial domain manager configured to update a record associating a geospatial identifier and a first network identifier, the geospatial identifier identifying a geospatial location at least partially included in the geospatial region identified by the geospatial domain and associated with a node identified by the first network identifier;
a change agent component configured to generate a message including change information based on the updating, wherein the message identifies a second record identifying the node at a second network directory service representing a second domain in a second domain space; and
a domain space agent component configured to send the generated message to the second network directory service for updating the second record,
wherein at least one of the system components includes at least one electronic hardware component.

36. The system of claim 35 wherein the second network domain space has nodes at least partially included in a network providing communication between nodes in the geospatial domain space and nodes in the second network domain space.

37. The system of claim 35 wherein the geospatial domain manager component is further configured to receive update information for updating the first record.

38. The system of claim 37 wherein the change information is based upon the update information.

39. The system of claim 37 wherein the geospatial domain manager component is configured to receive the update information from at least one of another network directory service node in the first network directory system, a persistent data store, and an inter-domain change message.

40. The system of claim 35 wherein the geospatial domain manager component is configured to receive update information for updating the first record from an other network directory service that has made a determination that the update information does not require a record managed by the other network directory service to be updated.

41. The system of claim 35 the geospatial domain manager component is configured to receive receiving update information for updating the first record from an other network directory system that has updated a record in the other network directory system using the update information.

42. The system of claim 35 wherein the geospatial domain manager component is configured to receive update information for updating the first record via user input.

43. The system of claim 42 wherein receiving update information for updating the first record via user input comprises receiving update information for updating the first record via user input from at least one of a local interface and a remote interface in communication with the first network directory system.

44. The system of claim 35 further comprising a geospatial network identifier to geospatial identifier database for use when the node identified by the first network identifier is associated with more than one geospatial location.

45. The system of claim 44 wherein the at least one of the more than one geospatial location is at least partially included in regions of other domains that the first network directory system represents.

46. The system of claim 45 wherein the at least one of the more than one geospatial location is associated with other network domain spaces.

47. A computer readable medium embodying a computer program, executable by a machine, for maintaining consistency between non-geospatial and geospatial network directory systems, the computer program comprising executable instructions for:
updating, by a first network directory service representing a first domain in a first domain space, a first record associating first location information and a first network identifier, the first location information identifying a geospatial location associated with a node identified by the first network identifier;
generating a message including change information based on the updating, wherein the message identifies a second record identifying the node at a second network directory service representing a geospatial domain in a second domain space, the geospatial domain identifying a geospatial region at least partially including the geospatial location; and
sending the generated message to the second network directory service for updating the second record.

48. A computer readable medium embodying a computer program, executable by a machine, for maintaining consistency between non-geospatial and geospatial network directory systems, the computer program comprising executable instructions for:
updating, by a first network directory service representing a geospatial domain in a geospatial domain space, a record associating a geospatial identifier and a first network identifier, the geospatial identifier identifying a geospatial location at least partially included in the geospatial region identified by the geospatial domain and associated with a node identified by the first network identifier;
generating a message including change information based on the updating, wherein the message identifies a second record identifying the node at a second network directory service representing a second domain in a second domain space;
sending the generated message to the second network directory service for updating the second record.
